(19) United States
(12) Patent Application Publication
(10) Pub. No.: US 2012/0113559 A1
(43) Pub. Date: May 10, 2012

(54) ELECTROSTATIC DISCHARGE PREVENTION FOR LARGE AREA SUBSTRATE PROCESSING SYSTEM

(75) Inventors: Hung T. Nguyen, Fremont, CA (US); George Tzeng, Sunnyvale, CA (US); Daniel I. Handjojo, Fremont, CA (US); Paul Bocian, Saratoga, CA (US); Matthias Brunner, Kirchheim (DE); Bernhard G. Mueller, Finsing (DE)

(73) Assignee: APPLIED MATERIALS, INC., Santa Clara, CA (US)

(21) Appl. No.: 13/288,743

(22) Filed: Nov. 3, 2011

Related U.S. Application Data
(60) Provisional application No. 61/411,902, filed on Nov. 9, 2010.

(51) Int. Cl. H05F 3/00

(52) U.S. Cl. 361/221

(57) ABSTRACT

Embodiments of the invention relate to methods and apparatus for minimizing electrostatic discharge in processing and testing systems utilizing large area substrates in the production of flat panel displays, solar panels, and the like. In one embodiment, an apparatus is described. The apparatus includes a testing chamber, a substrate support disposed in the testing chamber, the substrate support having a substrate support surface, a structure disposed in the testing chamber, the structure having a length that spans a width of the substrate support surface, the structure being linearly movable relative to the substrate support, and a brush device having a plurality of conductive bristles coupled to the structure and spaced a distance away from the substrate support surface of the substrate support, the brush device electrically coupling the support surface to ground through the structure.

### CROSS-REFERENCE TO RELATED APPLICATIONS

This application claims benefit of U.S. Provisional Patent Application Ser. No. 61/411,902 (APPM 15794L), filed Nov. 9, 2010, which is hereby incorporated by reference herein.

### BACKGROUND OF THE INVENTION

1. Field of the Invention

Embodiments of the present invention generally relate to methods and apparatus for minimizing electrostatic discharge in substrate processing and testing systems. More particularly, the invention relates to methods and apparatus for minimizing electrostatic discharge in processing and testing systems utilizing large area substrates in the production of flat panel displays, solar panels, and the like.

2. Description of the Related Art

Electronic devices, such as thin film transistors (TFT's), photovoltaic (PV) devices or solar cells, and other electronic devices, have been fabricated on substrates for many years. The TFT's and PV devices are typically interconnected to form a product, such as a flat panel display or solar panel, that is packaged and marketed to consumers.

The electronic devices are formed by numerous processes, which are often performed in different chambers. Moving the substrates between support surfaces in various chambers sometimes generates static electricity, which may produce an electrostatic discharge (ESD) event. ESD events may cause damage to finished electronic devices, as well as partially finished electronic devices. The damage may result in an unusable electronic device, which may render the product unusable.

Therefore, there is a need for apparatus and methods to prevent electrostatic discharge from occurring in the manufacture and/or testing of electronic devices.

### SUMMARY OF THE INVENTION

Embodiments of the invention relate to methods and apparatus for minimizing electrostatic discharge in processing and testing systems utilizing large area substrates in the production of flat panel displays, solar panels, and the like.

In one embodiment, an apparatus is described. The apparatus includes a testing chamber, a substrate support disposed in the testing chamber, the substrate support having a substrate support surface, a structure disposed in the testing chamber, the structure having a length that spans a width of the substrate support surface, the structure being linearly movable relative to the substrate support, and a brush device having a plurality of conductive bristles coupled to the structure and spaced a distance away from the substrate support surface of the substrate support, the brush device electrically coupling the support surface to ground through the structure.

In another embodiment, an apparatus is described that includes a testing chamber coupled to a load lock chamber, a substrate support disposed in the testing chamber, the substrate support being movable in a first linear direction, an end effector that is movably coupled to the substrate support, the end effector being movable in a second linear direction relative to the substrate support, and a brush device coupled to the end effector and disposed adjacent a processing surface of the substrate support, the brush device comprising a length that spans a width of the processing surface, wherein the brush device electrically couples the substrate support to ground through the end effector.

In another embodiment, an apparatus is described that includes a chamber coupled to a load lock chamber, a substrate support disposed in the chamber, the substrate support being movable in a first linear direction, an end effector movably disposed on the substrate support, a prober device that is movably coupled to the substrate support, the prober device being independently movable in a second linear direction relative to the substrate support, and a plurality of conductive bristles coupled to the prober device and spanning a width of the processing surface, each of the conductive bristles being spaced a distance from the processing surface of the substrate support, wherein the plurality of conductive bristles electrically couples the processing surface to ground through the prober device.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an isometric view of one embodiment of a test system.

FIG. 2A is a sectional side view of the test system shown in FIG. 1.

FIG. 2B is an isometric view of a portion of the substrate support shown in FIG. 2A.

FIG. 3 is an isometric view of a portion of a substrate support that may be utilized in the test system shown in FIG. 1.

FIG. 4A is a side view of one embodiment of a support member having one embodiment of a brush device disposed thereon.

FIG. 4B is an isometric view of the support member and the brush device shown in FIG. 4A.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The term substrate as used herein refers generally to large area substrates made of glass, a polymeric material, or other substrate materials suitable for having an electronic device formed thereon. Various embodiments are described herein relate to electrostatic discharge (ESD) prevention during testing of electronic devices, such as thin-film transistors (TFT's) and pixels located on flat panel displays. The testing procedures are exemplarily described using an electron beam or charged particle emitter, but certain embodiments described herein may be equally effective using optical devices, such as charge coupled device (CCD) cameras, charge sensing devices, or other testing applications configured to test electronic devices on large substrates in vacuum conditions, or at or near atmospheric pressure. Other electronic devices that may be located on a large area substrate and tested include photovoltaic cells for solar cell arrays, organic light emitting diodes (OLED's), among other devices. The methods and apparatus for ESD prevention as described herein may also be applicable for these other electronic devices.

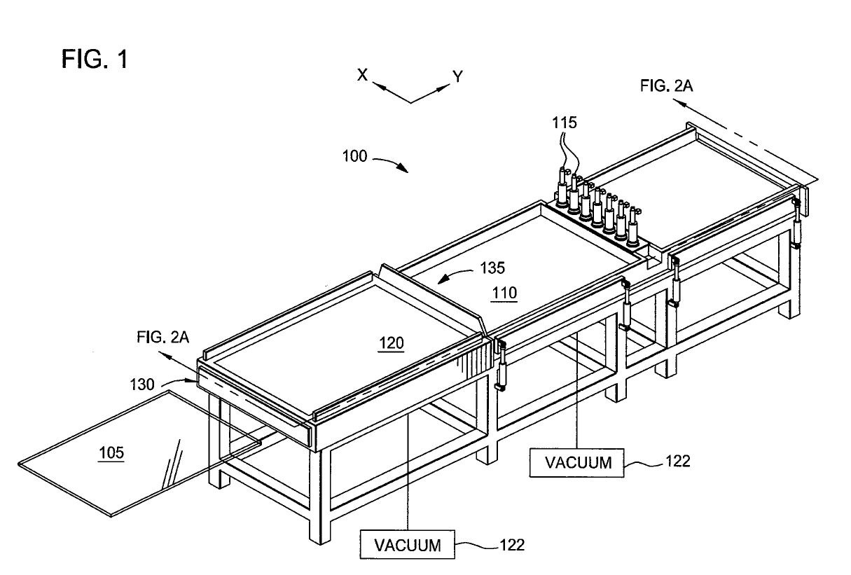

FIG. 1 is an isometric view of one embodiment of a test system 100 adapted to test the operability of electronic devices located on substrates, for example, substrates having dimensions up to and exceeding about 2200 mm by about 2600 mm. The test system 100 includes a testing chamber 110, a load lock chamber 120, and a plurality of testing columns 115 (seven are shown in FIG. 1), which are exemplarily described as electron beam columns adapted to test electronic devices located on substrates, such as TFT's. The test system 100 is typically located in a clean room environment and may be part of a manufacturing system that includes substrate handling equipment such as robotic equipment or a conveyor system that transports one or more substrates 105 to and from the testing chamber 110.

The interior of the testing chamber 110 is accessible at least through a valve 135 located between the load lock chamber 120 and the testing chamber 110. The load lock chamber 120 is selectively sealable from ambient environment and is typically coupled to one or more vacuum pumps 122. The testing chamber 110 may be coupled to one or more vacuum pumps 122 that are separate from the vacuum pumps of the load lock chamber 120. The load lock chamber 120 is adapted to receive the substrate 105 from the clean room environment through a sealable entry port 130, facilitate transfer of the substrate 105 from the load lock chamber 120 to the testing chamber 110 through the valve 135, and return the substrate 105 to the clean room environment through the load lock chamber 120 in a converse manner.

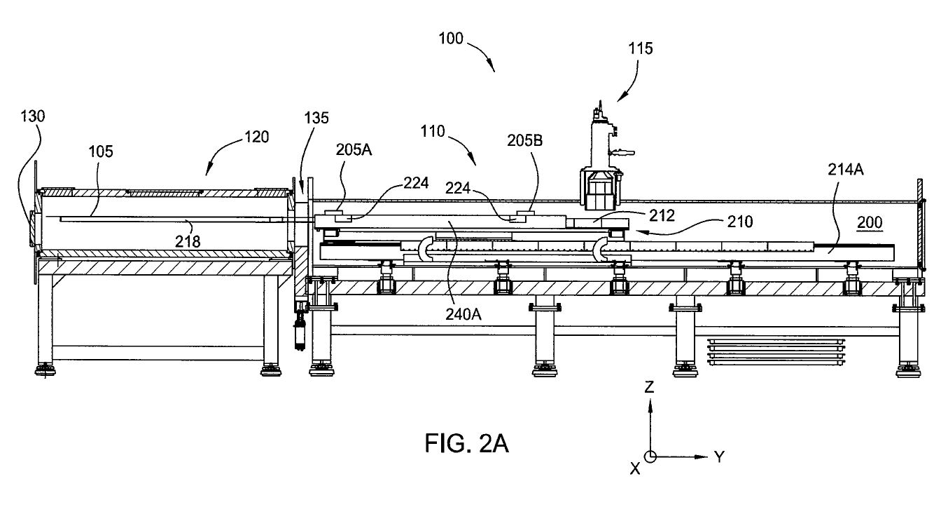

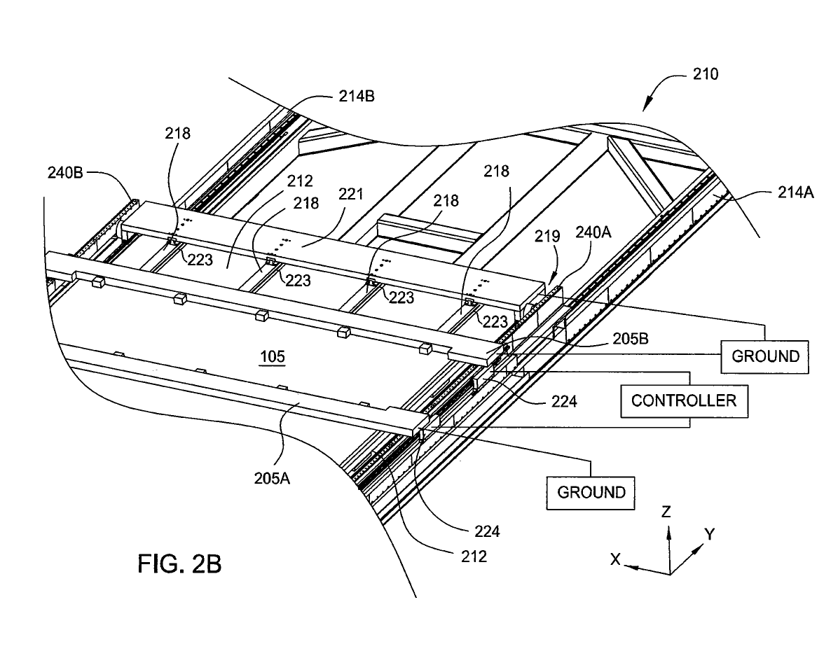

FIG. 2A is a side view of the test system 100 shown in FIG. 1. The testing chamber 110 is shown coupled to the load lock chamber 120, which includes a substrate 105 disposed therein. The testing chamber 110 includes an interior volume 200, which includes a substrate support 210 disposed and movable along frames 214A, 214B (only 214A is shown in FIG. 2A), two prober assemblies, such as prober 205A and prober 205B. The probers 205A and 205B are utilized to selectively contact conductive areas on the substrate 105 in order to test the operability of the electronic devices on the substrate 105. In one aspect, each of the probers 205A and 205B are configured as gantry structures that span a width of the substrate 105 and the substrate support 210.

The substrate support 210 is movable throughout the length of the interior volume 200 along the frame 214A by a drive (not shown) coupled between the frame 214A and the substrate support 210. The probers 205A, 205B are at least partially supported and movable along a prober support 240A, 240B on opposing sides (only 240A is shown in FIG. 2A) of the substrate support 210.

An upper stage 212 is configured to support the substrate 105 during testing and includes multiple panels having slots therebetween to receive a plurality of fingers 218 of an end effector 219 (shown in FIG. 2B). The upper stage 212 may be fabricated from a conductive material, such as aluminum. The upper stage 212 moves at least in the Z direction and the fingers 218 of the end effector 219 extend laterally (Y direction) therefrom to transfer the substrate 105 to and from the load lock chamber 120.

FIG. 2B is an isometric view of a portion of the substrate support 210 shown in FIG. 2A. A substrate 105 is located on the upper stage 212 of the substrate support 210. Probers 205A, 205B are shown on an upper surface of the prober supports 240A, 240B above the substrate 105. The probers 205A, 205B are adapted to move along the length of the prober supports 240A, 240B by a plurality of drives 224 coupled between the prober supports 240A, 240B and opposing sides of each prober 205A, 205B. The probers 205A and 205B are utilized to selectively contact conductive areas on the substrate 105 and provide, or sense, electrical signals from the electronic devices on the substrate 105.

The end effector 219 is shown proximate the upper stage 212 of the substrate support 210. In one aspect, the end effector 219 comprises gantry structure that spans the width of the substrate support 210. The gantry structure may be configured as a wrist 221 that supports the fingers 218. During testing, the fingers 218 are disposed in slots 223 formed in the upper stage 212. When the fingers 218 are disposed in the slots 223, the substrate 105 may contact the upper surface of the upper stage 212. During substrate transfer, the wrist 221 travels along the length of the upper stage 212. The wrist 221 is adapted to move adjacent the upper surface 315 of the upper stage 212. Both of the wrist 221 and the probers 205A, 205B are shown coupled to ground in FIG. 2B. One or both of the wrist 221 and probers 205A, 205B may be utilized to minimize ESD and removal of charge(s) from the substrate 105, the upper stage 212, and combinations thereof, as will be explained further below.

ESD is a sudden electric current that runs through one or more objects having a different electrical potential caused by direct contact or electrostatic field(s). ESD is usually created by tribocharging. Tribocharging may occur when two materials that have been in contact are separated. Tribocharging may also occur by friction from relative motion between two materials. ESD causes damages on circuits within the electronic devices on the substrate 105. The potential for ESD may be present during transfer of the substrate 105 to and from the fingers 218 and the upper stage 212. Thus, an electrical potential between the substrate 105 and the end effector 219 may be present before and after transfer of the substrate 105. Different electrical potentials may also remain during testing of the substrate 105.

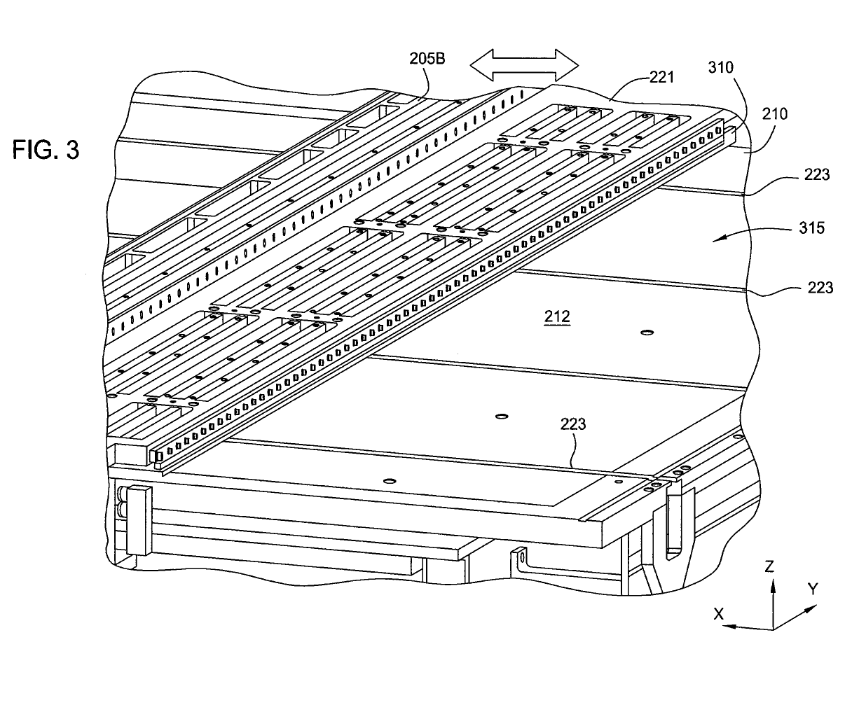

FIG. 3 is an isometric view of a portion of a substrate support 210 that may be utilized in the test system 100 shown in FIG. 1. The wrist 221 includes a brush device 310 coupled thereon. The brush device 310 is coupled to the wrist 221 and is adapted to be adjacent or contact an upper surface 315 of the upper stage 212. The brush device 310 is adapted to move across the upper surface 315 along with the wrist 221 during substrate transfer. The brush device 310 is configured to remove electrical charge(s) from the upper stage 212. For example, electrical charges from the upper surface 315 may be transferred to ground through the brush device 310 to the wrist 221, which is coupled to ground as shown in FIG. 2B.

Thus, the brush device 310 is adapted to remove or dissipate any electrical potential that may have been generated by the substrate 105, the upper surface 315 of the upper stage 212, and combinations thereof. The electrical charge may go to ground from the upper surface 315 of the upper stage 212 through the wrist 221 and the brush device 310.

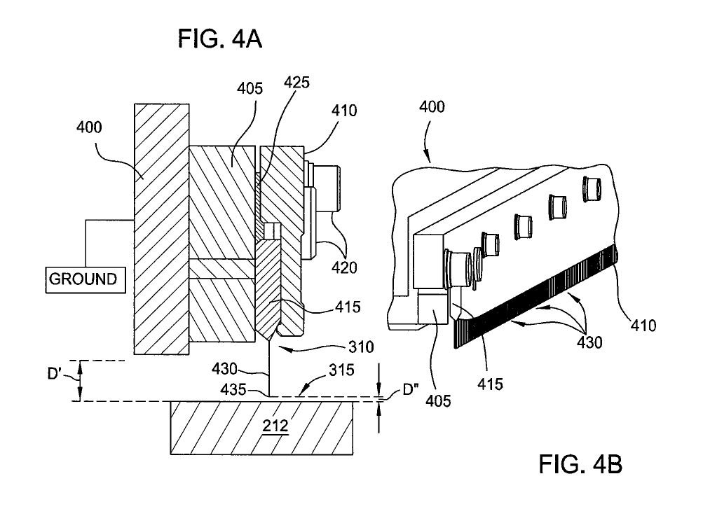

FIG. 4A is a side view of one embodiment of a support member 400 having one embodiment of a brush device 310 disposed thereon. The support member 400 is depicted adjacent the upper stage 212 shown in FIG. 3. The support member 400 may be any structure having a dimension greater than the width of a substrate and/or a dimension greater than the width of the upper stage 212. The support member 400 may also be movable relative to the upper stage 212. For example, the support member 400 may be a surface of a prober 205A, 205B (shown in FIGS. 2A-3) or the wrist 221 (shown in FIGS. 2B and 3). One embodiment of the brush device 310 is shown coupled to the support member 400. FIG. 4B is an isometric view of the support member 400 and the brush device 310 shown in FIG. 4A.

The brush device 310 includes a mounting plate 405 that is coupled to the support member 400. The brush device 310 also includes a spine 415 that is pressed against a mounting bracket 410. The mounting bracket 410 may be secured to the mounting plate 405 by one or more fasteners 420, such as bolts or screws. A washer or spacer 425 may be utilized between the mounting plate 405 and the mounting bracket 410.

The brush device 310 comprises a plurality of conductive bristles 430. At least the support member 400, the mounting bracket 410 and the mounting plate 405 are made of a conductive material, such as aluminum. The plurality of conductive bristles 430 are coupled to the conductive spine 415. Each of the conductive bristles 430 may comprise a conductive polymer, carbon fiber, fabrics or plastics coated with a conductive material, fine strands of a soft conductive metal, or combinations thereof. Likewise, the spine 415 comprises a conductive material. The spine 415 may be formed as a structure adapted to be sandwiched between the mounting bracket 410 and the mounting plate 405. The spine 415 may be conductive fibers or fabrics binding the conductive bristles 430 to each other, or fine conductive strands or wires that bind the bristles to each other. The spine 415 may also include ends of the conductive bristles 430 that are encapsulated in a conductive binder shell.

In one embodiment, the conductive bristles 430 comprise a conductive fabric, such as nylon. In another embodiment, the conductive bristles 430 comprise a acrylic fiber having a conductive coating disposed thereon, such as THUNDERON® anti-static materials. The conductive bristles 430 may have a diameter of about 15 micrometers (μm) to about 19 μm. In embodiments having a conductive coating, the conductive coating disposed on the conductive bristles 430 may have a thickness of about 300 angstroms (Å) to about 1000 Å. The conductive bristles 430 are coupled to ground through the support member 400, which may be a surface of one or more of the probers 205A, 205B, or the wrist 221, which are coupled to ground as shown in FIG. 2B.

The brush device 310 may be in close proximity with the substrate 105 (shown in FIG. 2A) or the upper surface 315 of the upper stage 212, such as within a few millimeters, to remove the electrical charge(s). Alternatively, the brush device 310 may be in direct contact with the substrate 105 or the upper surface 315 of the upper stage 212 to remove the electrical charge(s).

During movement of the support member 400 relative to the upper surface 315 of the upper stage 212, the lower surface of the support member 400 may be maintained at a distance D′ from the upper surface 315. The distance D′ may be between about 2 mm to about 10 mm, such as about 5 mm to about 10 mm. Likewise, a distal end 435 of the conductive bristles 430 may be maintained a distance D″ away from the surface to prevent the conductive bristles 430 from contacting the upper surface 315 in order to prevent particle generation. The distance D″ may be about 1 mm to about 8 mm above the upper surface 315, such as about 3 mm to about 6 mm from the upper surface 315 of the upper stage 212, which is close enough to the substrate 105 and/or the upper surface 315 to prevent an ESD event.

Embodiments described herein provide and apparatus and method for dissipating electrical potential from a surface of a substrate or a substrate support 210 in order to prevent an ESD event. The apparatus includes a support member 400 having a dimension that is greater than the substrate width and/or greater than a width of the substrate support 210. The support member 400 may also be configured as a gantry structure that is movable relative to the substrate and the substrate support 210. A brush device 310 is coupled to the support member 400 and movable with the support member 400. The support member 400 is coupled to ground to allow charge(s) that may build up on the substrate and/or the upper surface 315 of the substrate support 210 to be transferred to ground. The brush device 310 may be spaced away from the substrate and the substrate support 210 to prevent particle generation while removing charge(s).

While the foregoing is directed to embodiments of the present invention, other and further embodiments of the invention may be devised without departing from the basic scope thereof, and the scope thereof is determined by the claims that follow.

1. An apparatus, comprising:
a testing chamber;
a substrate support disposed in the testing chamber, the substrate support having a substrate support surface;
a structure disposed in the testing chamber and linearly movable relative to the substrate support, the structure having a length that spans a width of the substrate support surface; and
a brush device having a plurality of conductive bristles coupled to the structure and spaced a distance away from the substrate support surface of the substrate support, the brush device electrically coupling the substrate support surface to ground through the structure.

2. The apparatus of claim 1, wherein the structure comprises a prober device.

3. The apparatus of claim 1, wherein the structure comprises an end effector wrist.

4. The apparatus of claim 1, wherein the substrate support surface is disposed in a vacuum chamber.

5. The apparatus of claim 1, wherein the brush device spans the length of the structure.

6. The apparatus of claim 1, wherein each of the conductive bristles comprise a fabric having a conductive coating disposed thereon.

7. The apparatus of claim 1, wherein the distance is about 2 mm to about 5 mm.

8. An apparatus, comprising:
a testing chamber coupled to a load lock chamber;
a substrate support disposed in the testing chamber, the substrate support being movable in a first linear direction;
an end effector that is movably coupled to the substrate support, the end effector being movable in a second linear direction relative to the substrate support; and
a brush device coupled to the end effector and disposed adjacent a processing surface of the substrate support, the brush device comprising a length that spans a width of the processing surface, wherein the brush device electrically couples the substrate support to ground through the end effector.

9. The apparatus of claim 8, wherein the brush device comprises a plurality of conductive bristles.

10. The apparatus of claim 9, wherein the conductive bristles have a distal end that is spaced a distance from the processing surface.

11. The apparatus of claim 10, wherein the distance is about 2 mm to about 5 mm.

12. The apparatus of claim 9, wherein the first direction is the same as the second direction.

13. The apparatus of claim 9, wherein the substrate support is disposed in a vacuum chamber.

14. An apparatus, comprising:
a chamber coupled to a load lock chamber;
a substrate support disposed in the chamber, the substrate support being movable in a first linear direction;
an end effector movably disposed on the substrate support;
a prober device that is movably coupled to the substrate support, the prober device being independently movable in a second linear direction relative to the substrate support; and
a plurality of conductive bristles coupled to the prober device and spanning a width of the processing surface, each of the conductive bristles being spaced a distance from the processing surface of the substrate support, wherein the plurality of conductive bristles electrically couples the processing surface to ground through the prober device.

15. The apparatus of claim 14, wherein the distance is about 2 mm to about 5 mm.

16. The apparatus of claim 15, wherein the first direction is the same as the second direction.

17. The apparatus of claim 15, wherein the substrate support is disposed in a vacuum chamber.

18. The apparatus of claim 14, wherein the plurality of conductive bristles are coupled to a spine.

19. The apparatus of claim 18, wherein the spine is sandwiched between a mounting bracket and a mounting plate.

20. The apparatus of claim 18, wherein the spine comprises a plurality of conductive fibers disposed in a conductive shell.
